(19) United States
(12) Patent Application Publication
(10) Pub. No.: US 2008/0062189 A1
(43) Pub. Date: Mar. 13, 2008

(54) Method for automatically unfolding a computer monitor when starting a notebook

(76) Inventors: Liang Zhao, Taipei (TW); Tom Chen, Taipei (TW); Win-Harn Liu, Tianjin (CN)

Correspondence Address: HARNESS, DICKEY & PIERCE, P.L.C., P.O. BOX 8910, RESTON, VA, 20195, US

(21) Appl. No.: 11/519,085

(22) Filed: Sep. 12, 2006

(51) Int. Cl. G09G 5/00

(52) U.S. Cl. 345/581

(57) ABSTRACT

According to a method for automatically unfolding a computer monitor when starting a notebook, the opening speed of the computer monitor is determined, according to a predetermined starting time needed for a computer starting program (for example, the average time needed for the operating system initialization after activating the notebook) and a predetermined opening angle of the computer monitor, after the notebook is started. Meanwhile, a shaft coupled to the computer monitor is controlled through an on-off device according to the opening speed of the computer monitor, to unfold the computer monitor to a using position. This greatly facilitates the usage of a notebook upon its starting and activating. Further, its design is more convenient.

### BACKGROUND OF THE INVENTION

1. Field of Invention

The present invention relates to a method for starting a notebook and unfolding the computer monitor, in particular to a method for automatically unfolding the computer monitor after the notebook is started and activated.

2. Related Art

Presently, while using a notebook, a user must first manually flip open the monitor of the notebook to a particular using position, and then press a start button to activate the notebook and wait for entering the operating system. It costs about one minute from the moment of the user flips open the monitor and presses the start button until the computer completely enters its operating system (for example, when the desktop of a Windows operating system on the computer monitor is fully displayed for the user to perform subsequent operations). During such a period of about one minute, the notebook simply is activated and enters the operating system, and the user does nothing but wait patiently until the computer is activated and completely enters the operating system, then the user can perform the subsequent operations. For all the notebook users, the whole waiting process is stereotyped, this is very dull and boring.

### SUMMARY OF THE INVENTION

The object of present invention is to provide a method for automatically unfolding a computer monitor when starting a notebook, the method comprising: triggering a computer monitor opening key, while activating a notebook starting program; determining the opening speed of the computer monitor according to a predetermined starting time needed for the starting program and a predetermined opening angle of the computer monitor; controlling a shaft coupled to the computer monitor through an on-off device and according to the opening speed of the computer monitor, to unfold the computer monitor to a using position. The method of the present invention for automatically unfolding a computer monitor when starting a notebook is to automatically unfold the monitor of the notebook to a using position according to the average time needed for the operating system initialization after activating the notebook and the predetermined opening angle of the computer monitor set by different users, to greatly facilitate the usage of a notebook upon its starting and activating and have a more convenient design.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, wherein:

FIG. 1 is a flow chart of a method of the present invention for automatically unfolding a computer monitor when starting a notebook.

### DETAILED DESCRIPTION OF THE INVENTION

Hereinafter, the preferred embodiment of the present invention will be described in detail with reference to the accompanying drawings.

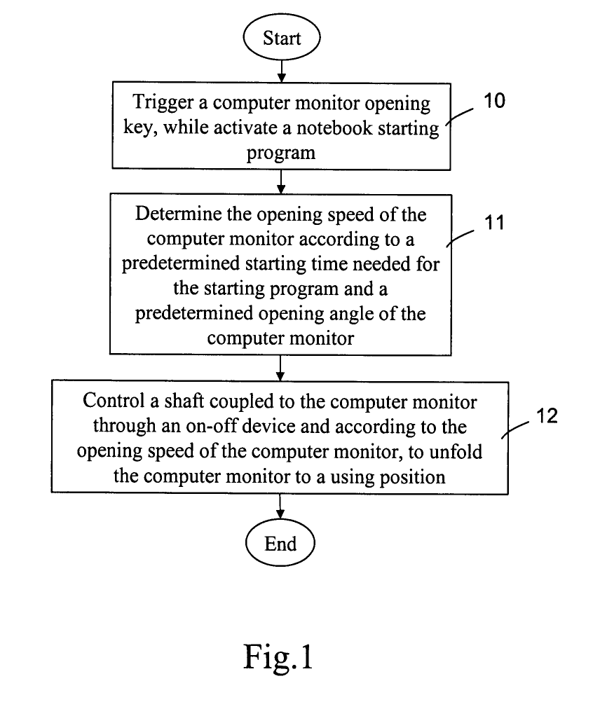

FIG. 1 is a flow chart of a method of the present invention for automatically unfolding the computer monitor when starting a notebook. As shown, the method includes the following steps:

Switching on an activating switch of the notebook through pressing a start button on the shell of the notebook or through remote controlling via a remote controller, to activate a notebook starting program (Step 10);

Determining an opening speed of the computer monitor according to a predetermined starting time needed for the starting program and a predetermined opening angle of the computer monitor (Step 11); and

Controlling a shaft coupled to the computer monitor through an on-off device and according to the opening speed of said computer monitor, to unfold the computer monitor to a using position (Step 12).

The predetermined starting time in the above steps is the average time needed for the operating system initialization after activating the notebook, resulted from the calculation and analysis through a timing module in the notebook.

The predetermined opening angle of the computer monitor in the above steps is set upon the needs of different users, and there may be various specific setting means. One of the various specific setting means is to set up the rotating angle of the computer monitor on the shaft coupled thereto according to the user's own need, through a limit clasp arranged on the shaft coupled to the computer monitor, so that the computer monitor can be rotated and opened to varied positions according to the using positions of different users.

The opening speed of the computer monitor in the above steps is calculated through a data analysis module in the notebook as a function of the predetermined starting time and the predetermined opening angle of the computer monitor as described above.

The on-off device in the above steps is a pneumatic or hydraulic on-off device, or an electrically driven mechanical on-off device arranged at said shaft, coupled to the computer monitor. The on-off device controls the shaft coupled to the computer monitor, under the control of a logic control unit in the notebook and according to the calculated opening speed of the computer monitor, to unfold the computer monitor to a using position.

As mentioned above, according to the method of present invention for automatically unfolding the computer monitor when starting a notebook, the monitor of the notebook is automatically unfolded. This process is according to the average time needed for the operating system initialization after activating the notebook and the predetermined opening angle of the computer monitor, set by different users. This greatly facilitates the usage of a notebook upon its starting and activating. Further, its design is more convenient.

Knowing the invention being thus described, it will be obvious that the same may be varied in many ways. Such variations are not to be regarded as a departure from the spirit and scope of the invention, and all such modifications as would be obvious to one skilled in the art, are intended to be included within the scope of the following claims.

What is claimed is:

1. A method for automatically unfolding a computer monitor when starting a notebook, said method comprising:
triggering a computer monitor opening key, while activating the notebook starting program;
determining the opening speed of the computer monitor according to a predetermined starting time needed for said starting program and a predetermined opening angle of said computer monitor; and
controlling a shaft coupled to the computer monitor through an on-off device and according to the opening speed of said computer monitor, to unfold the computer monitor to a using position.

2. The method as claimed in claim 1, further comprising triggering the computer monitor opening key through a remote controller.

3. The method as claimed in claim 1, wherein said predetermined starting time is the average time needed for the operating system initialization after starting the notebook.

4. The method as claimed in claim 1, wherein said predetermined opening angle of the computer monitor is set depending on the needs of different users.

5. The method as claimed in claim 4, further comprising setting said predetermined opening angle through a limit clasp arranged on said shaft coupled to the computer monitor.

6. The method as claimed in claim 1, wherein said on-off device is a pneumatic or hydraulic on-off device arranged at said shaft coupled to the computer monitor.

7. The method claimed in claim 1, wherein said on-off device is an electrically driven mechanical on-off device arranged at said shaft coupled to the computer monitor.
